(19) United States
(12) Patent Application Publication
(10) Pub. No.: US 2010/0328203 A1
(43) Pub. Date: Dec. 30, 2010

(54) Removable pads with a carrying case for a portable electronic device with a touch screen

(75) Inventor: Wei Hsu, Chung Ho City (TW)

Correspondence Address: BACON & THOMAS, PLLC, 625 SLATERS LANE, FOURTH FLOOR, ALEXANDRIA, VA, 22314-1176, US

(73) Assignee: Weistech Technology Co., LTD., Chung Ho City (TW)

(21) Appl. No.: 12/457,859

(22) Filed: Jun. 24, 2009

(51) Int. Cl. G06F 3/033; G06F 3/041

(52) U.S. Cl. 345/157; 345/173

(57) ABSTRACT

The invention discloses a kit for a portable electronic device with a touch screen, such as iPhone® and iPod touch®, wherein the kit comprises: removable pads, comprising at least one button pad, and/or at least one D-pad, wherein the button pad(s) and the D-pad(s) are able to be pressed to input instruction into the touch screen; and a carrying case, carrying the removable pads and fitting the portable electronic device for protection. The carrying case may further comprise a flip-up lid to keep the removable pads between the lid and the carrying case. The carrying case or the flip-up lid may comprise at least one hole for the button pad(s) and/or the D-pad(s) to fit the shape of the removable pads. The flip-up lid may have one end as a pivot mechanically connected to the carrying case with the other end capable of flipping up from the carrying case.

### TECHNICAL FIELD

Embodiments of the invention generally relate to the field of portable electronic devices with a touch screen, such as mobile phones and PDAs. More specifically, the present invention relates to the field of the interaction with these devices through removable pads disposed on the touch screen thereof.

### BACKGROUND

Grounded on the Press Release (Reston, Va. Jan. 30, 2009) provided by the marketing research company, comScore, Inc., audience for downloaded games grew 17 percent from November 2007 to November 2008 as 34 percent of mobile game downloaders in November 2008 owned a smartphone, compared with 10 percent last year. “The rapid growth in smartphone adoption in the United States has provided a boost for mobile gaming, as 34 percent of those downloading a game in November did so using a smartphone,” said Mark Donovan, senior analyst, comScore. “Last year, not one smartphone appeared in the top 10 devices used for mobile downloads. This year, six out of ten are smartphones, excluding devices with smartphone-like functionality, such as the Instinct® and Voyager®, which also make appearances.”

The iPhone® and BlackBerry Curve® have replaced the RAZR® and low-end flip phones as the most popular gaming platforms, according to comScore. In fact, the number of smartphone owners downloading a game nearly tripled, while dipping 14 percent among owners of feature phones. iPhone® owners accounted for 14 percent of mobile game downloaders in November 2008, with 32.4 percent of all iPhone® users reporting they downloaded a game in the month, compared with a market average of 3.8 percent of mobile subscribers, or 8.5 million people.

“As the mobile phone has evolved into a better platform for both playing and merchandising games, the games being offered have also been improved, drawing in a broader user base,” observed Donovan. “Over the past year, we have seen mobile gaming expand into a broadening demographic, with strongest growth among teens, who previously eschewed their mobile device in favor of handheld gaming devices, and those 35 and older.”

From the survey done by comScore, it is easy to find that users of smartphones, such as iPhone® users, are much more interested in mobile games than users of common cellular phones. Maybe this phenomenon is due to several reasons, among them the convenience of accessing the Web via smartphones, the larger screens of smartphones in general, the higher speed of retrieving the data, playing games with no lag, and the substantially different type of users who have bought a smartphone, a mobile phone with a touchpad, a personal digital assistant (PDA) equipped with a touch panel, or a portable electronic device with a touch screen. For example, users of smartphones, such as iPhone® users, are more willing to try something new and novel, like mobile games, and the cost is not their first concern.

However, while using a touchscreen, which is equipped to most of the smartphones, such as iPhone®, to play games, it does not feel like a “real” handheld game console, not feeling as good as real buttons or a real D-pad (short for directional pad) when playing certain kinds of games. Besides, as depicted in FIG. 1, the virtual D-pad 54 and virtual buttons 52 on a touch screen 51 of iPhone® 50 often disallow players to bring about satisfied results, i.e. higher scores; a user may become frustrated if action and/or motions of the protagonist or the cursor do not reflect the user's intent. Furthermore, most of the users play mobile games for fun, and they would like to experience the real contact with “real” buttons and a “real” D-pad or even a joystick, which is not allowed by a touch panel. Moreover, many users who download mobile games enjoy playing handheld game consoles very much, and they would desire their smartphones to simulate the consoles or game controllers while playing the games.

Accordingly, the present invention provides a kind of removable pads with a carrying case for portable electronic devices with a touch screen, e.g. iPhone® and iPod touch®, to overcome the deficiency of a touch screen which is unable to simulate the real consoles or game controllers while playing the games.

### SUMMARY OF THE INVENTION

It is one object of the present invention to provide a kind of removable pad(s) for a touch screen, wherein the removable pad(s) comprises at least one button pad, and/or at least one D-pad (short for directional pad), whereby the button pad(s) and the D-pad(s) are able to be pressed to input instruction into the touch screen.

The material of the removable pads can exert substantial friction against the touch screen. The material of the removable pads has a coefficient of friction to a considerable extent with respect to the touch screen so as to reduce relative movement between the removable pads and the touch screen. The material of the removable pads may include, but not limited to, rubber, resins, plastic resins, silicone rubber, elastomers, polymers, synthetic rubber, synthetic resins, synthetic materials, or the combination thereof. Furthermore, the material of the removable pads may have the elastic properties, be resilient and/or be flexible.

The removable pads may further include a carrying case for a portable electronic device with the touch screen, wherein the carrying case is able to carry the removable pads and fit the portable electronic device to protect therefrom.

It is another object of the present invention to disclose a kit for a portable electronic device with a touch screen, such as iPhone® and iPod touch®, wherein the kit comprises: removable pad(s), comprising at least one button pad, and/or at least one D-pad, wherein the button pad(s) and the D-pad(s) are able to be pressed to input instruction into the touch screen of the portable electronic device; and a carrying case, carrying the removable pad(s) and fitting the portable electronic device to protect therefrom.

The carrying case may further comprise a flat flip-up lid to keep the removable pad(s) between the flip-up lid and the carrying case. The flip-up lid may comprise at least one hole for the button pad(s) and/or the D-pad(s) to fit the shape of the removable pad(s), and the removable pad(s) is able to be embedded in the hole(s).

Moreover, the flat flip-up lid may have one end as a pivot mechanically connected to the carrying case with the other end capable of flipping up from the carrying case. Additionally, the flip-up lid may have one end comprising a living hinge or similar mechanism for allowing the other end to be separated into an open position.

Besides, the aforementioned removable pads may further include one or more joystick(s) able to control the touch screen as well.

A detailed description is given in the following embodiments with reference to the accompanying drawings.

### BRIEF DESCRIPTION OF THE DRAWINGS

Embodiments of the invention are illustrated by way of example, not by way of limitation, and the following figures relate particularly to preferred embodiments of the present invention. Like reference numerals refer to corresponding parts throughout the several views of the drawings.

FIG. 1 shows a schematic diagram of iPhone® with virtual buttons and a virtual D-pad on the touch screen thereof while playing games;

FIG. 2 shows a schematic diagram of removable button pads and a removable D-pad disposed onto the touch screen of iPhone® in accordance with a preferred embodiment of the invention;

FIG. 3 shows a schematic diagram of a carrying case fitting iPhone® in accordance with a preferred embodiment of the invention;

FIG. 4 shows a schematic diagram of the removable pads not in use and the carrying case fitting iPhone® in accordance with a preferred embodiment of the invention;

FIG. 5(A) and FIG. 5(B) show the other function of the carrying case with a flip-up lid as being a stand of iPhone®;

FIG. 6(A) and FIG. 6(B) show the carrying case with a flip-up lid lying horizontally as being a stand of iPhone®;

FIG. 7 shows a schematic diagram of another kind of carrying case fitting iPhone® in accordance with another preferred embodiment of the invention;

FIG. 8 shows a schematic diagram of a kit comprising a removable D-pad, seven removable button pads, and a carrying case for iPhone® in accordance with a preferred embodiment of the invention; without removable a lid for a portable electronic device keypad and a

FIG. 9 shows a schematic diagram of the kit in FIG. 8 and iPhone®; and

FIG. 10 shows a schematic diagram of the removable pads not in use and the carrying case fitting iPhone® in accordance with a preferred embodiment of the invention.

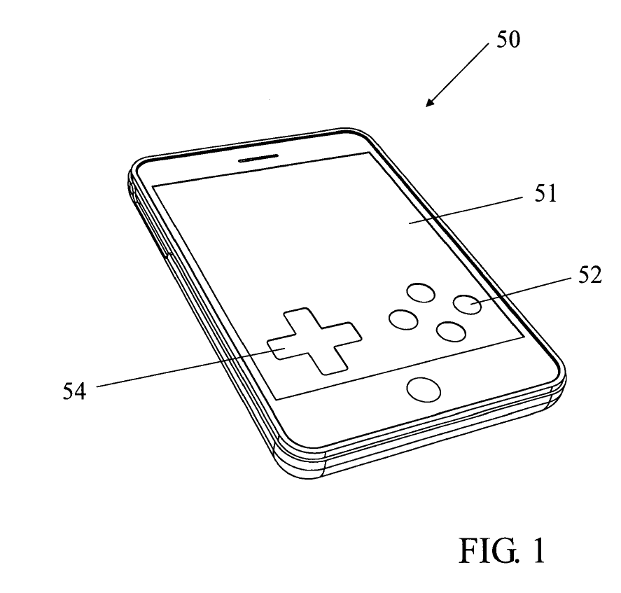

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended Claims.

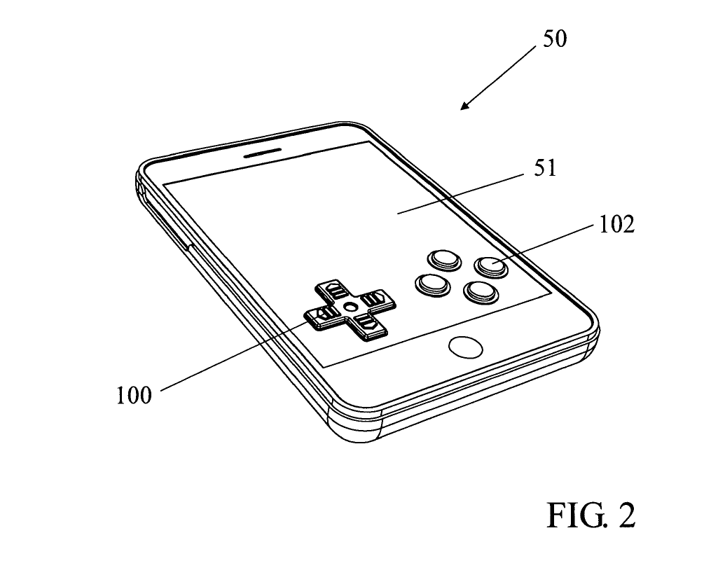

As indicated in FIG. 2, one preferred embodiment of the invention provides a kind of removable pads for a touch screen 51 of any mobile phone or portable electronic device 50, wherein the removable pads comprise a plurality of button pads 102, for example, four button pads, and one D-pad (a directional pad, a tetradirectional pad) 100, whereby the button pads 102 and the D-pad 100 are able to be pressed to input instruction into the touch screen 51 of a mobile phone such as iPhone® 50. When it comes to playing mobile games on the mobile phone 50 or a media player such as iPod touch®, users may put the removable pads (e.g. 100 and 102) onto the touch screen 51 easily and then enjoy playing games like using a real game controller for fun. The removable pads, for instance, 100 and 102, enable the users in contact with the mobile phone 50 to feel like interacting with a handheld game console. The instruction will be input from the touch screen 51 through the removable pads 100 and 102.

Moreover, the texture of the removable pads, including the button pads 102 and the D-pad 100, may imitate game controllers, handheld game consoles, or the like. The material of the removable pads can exert substantial friction against the touch screen 51 to be less slippery. Put differently, the material of the removable pads has a coefficient of friction to a considerable extent with respect to the touch screen 51 so as to reduce relative movement between the removable pads (e.g. 100 and 102) and the touch screen 51. The material of the removable pads may include, but not limited to, rubber, resins, plastic resins, silicone rubber, elastomers, polymers, synthetic rubber, synthetic resins, synthetic materials, or the combination thereof. Furthermore, the material of the removable pads may have the elastic properties, be resilient and/or be flexible to enable perfect contact with the touch screen 51 after pressing button pads 102 or the D-pad 100.

The removable pads can be designed for any portable electronic devices equipped with touch screens, for instance, smartphones, iPhone®, iPod touch®, PDAs, and mobile phones with touchpads.

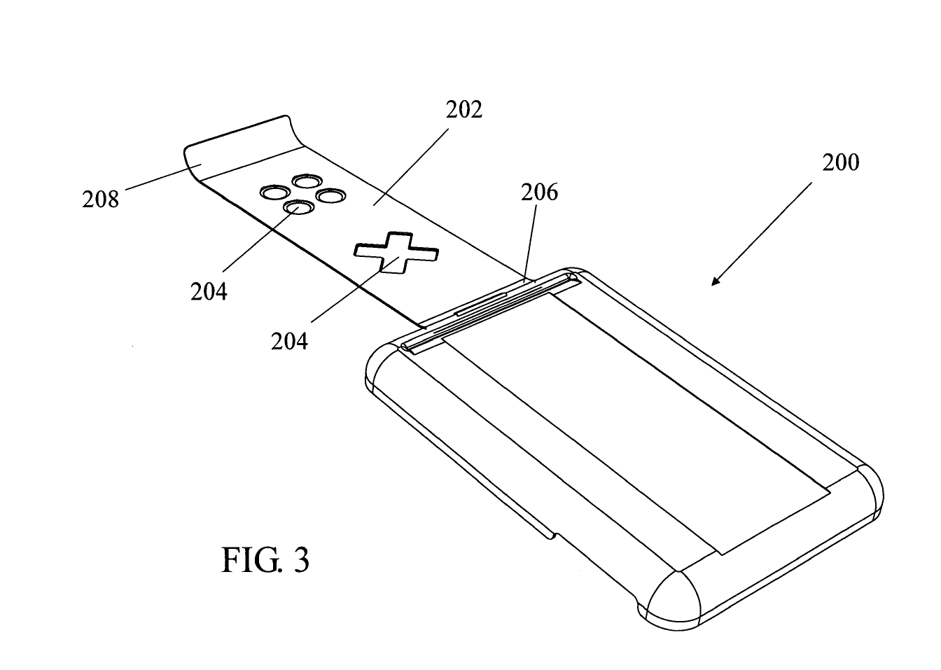

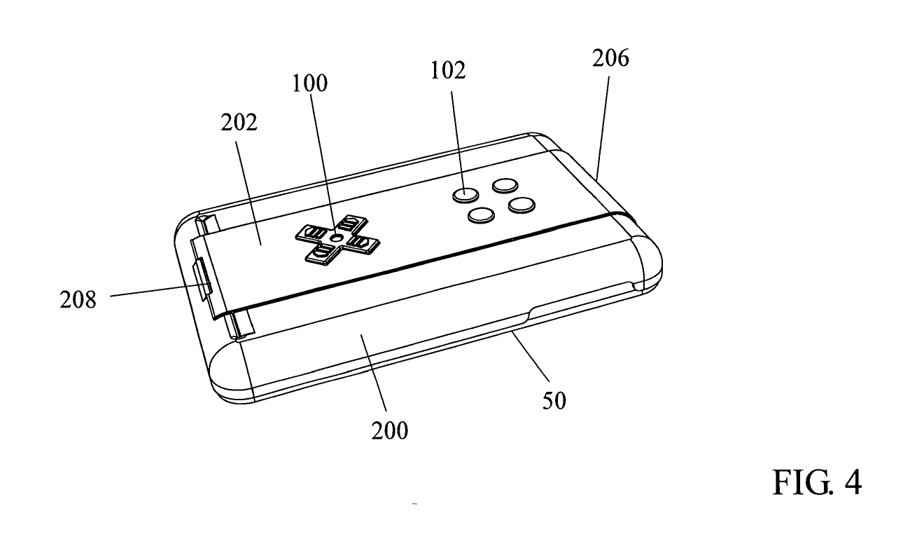

In a preferred embodiment, referring to FIG. 3, the removable pads may further include a carrying case 200 for a portable electronic device with the touch screen 51, such as iPhone® 50 (or iPod touch®), wherein the carrying case 200 is able to carry the removable pads (e.g. 100 and 102) and fit the portable electronic device, i.e. iPhone® 50, to protect therefrom. The carrying case 200 may further comprise a flat flip-up lid 202 to keep the removable pads (e.g. 100 and 102) between the flip-up lid 202 and the carrying case 200 while the removable pads are not in use (FIG. 4). The flat flip-up lid 202 may comprise five holes 204 for aforementioned four button pads 102 and the D-pad 100 to fit the shape of the removable pads (e.g. 100 and 102), and the removable pads (for example, 100 and 102) are able to be embedded in the holes 204 as illustrated in FIG. 4.

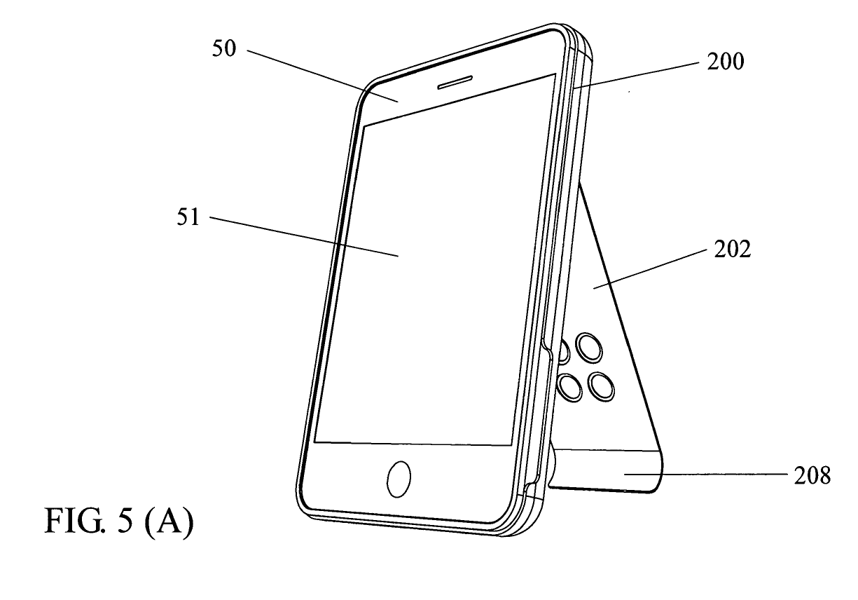

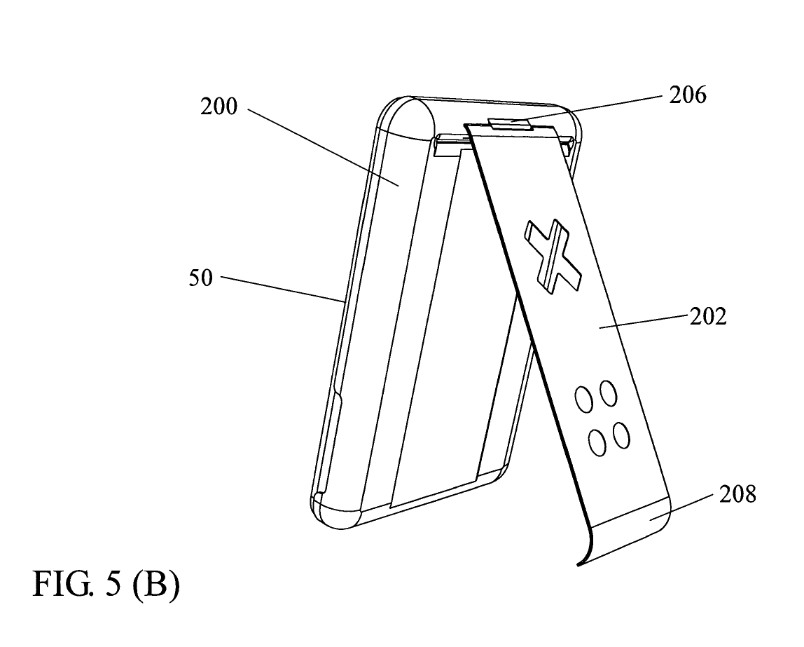

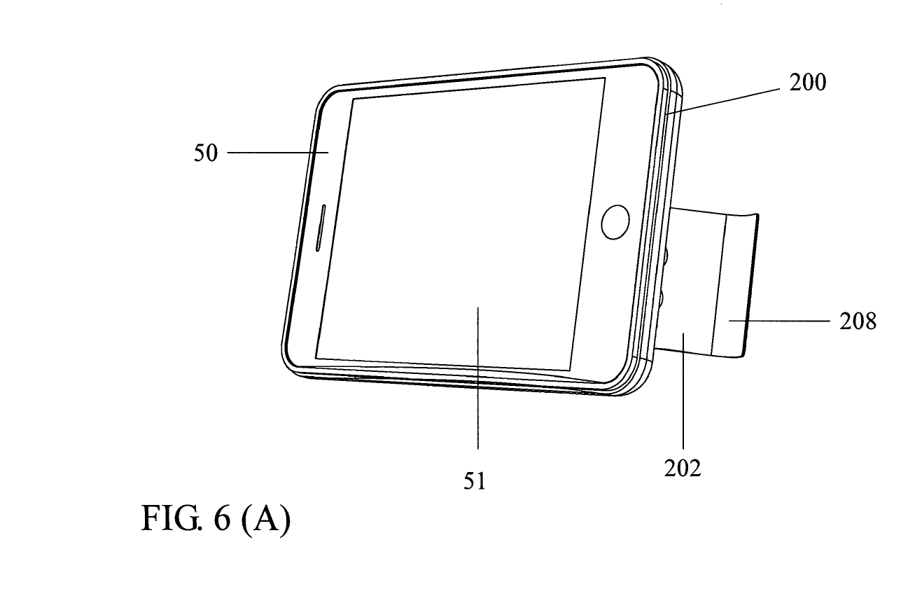

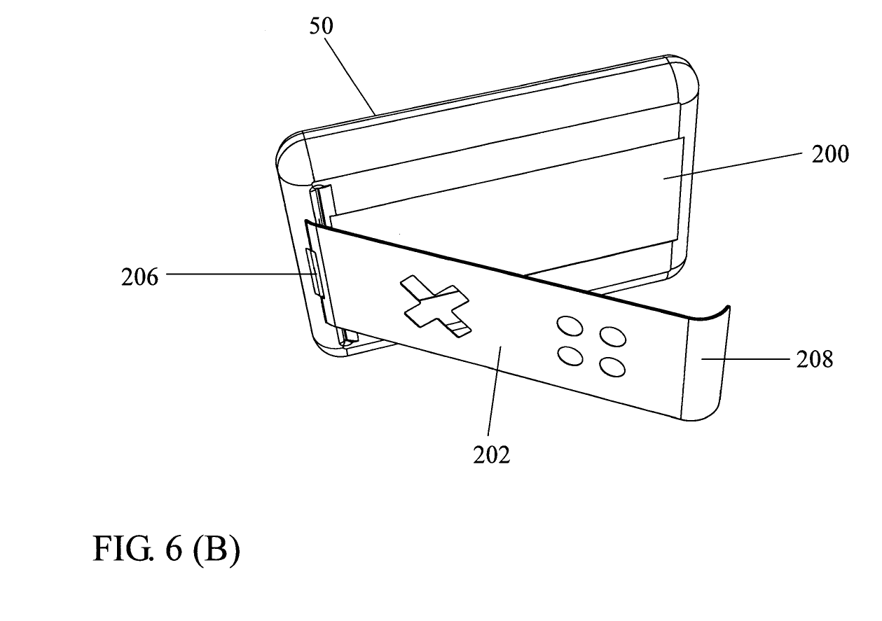

Additionally, the flat flip-up lid 202 may have one end 206 as a pivot mechanically connected to the carrying case 200 with the other end 208 capable of flipping up from the carrying case 200 (FIG. 3). Moreover, the flip-up lid 202 may have one end 206 comprising a living hinge or similar mechanism for allowing the other end 208 to be separated into an open position. Referring to FIG. 5(A) and FIG. 5(B), when the end 208 with no connectors to the carrying case 200 is separated from the carrying case 200 into an open position, the flip-up lid 202 may serve as a holder or a leg to support the portable electronic device, e.g. iPhone® 50 (or iPod touch®), which will enable the portable electronic device to “stand.” That means users may position their iPhone® 50 to “stand” at any desired angles by setting the open angle of the flip-up lid 202. In this way, users are able to stand their portable electronic devices against a table or even the floor to view pictures, see the movies, read the maps, and so on, as delineated in FIG. 6(A) and FIG. 6(B).

Besides, the aforementioned removable pads may further comprise one or more joystick(s) (not shown) which will be able to control the touch screen 51 as well.

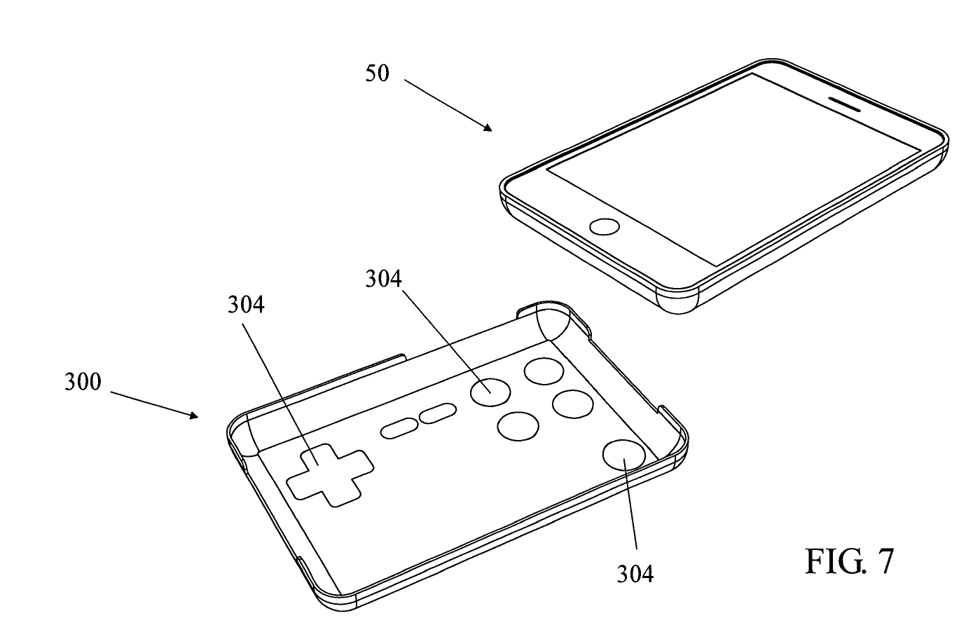

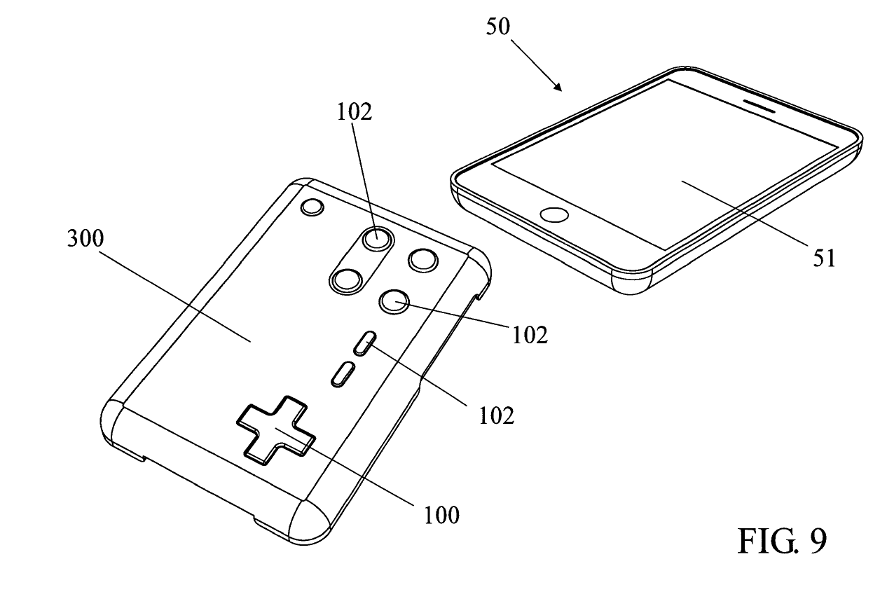

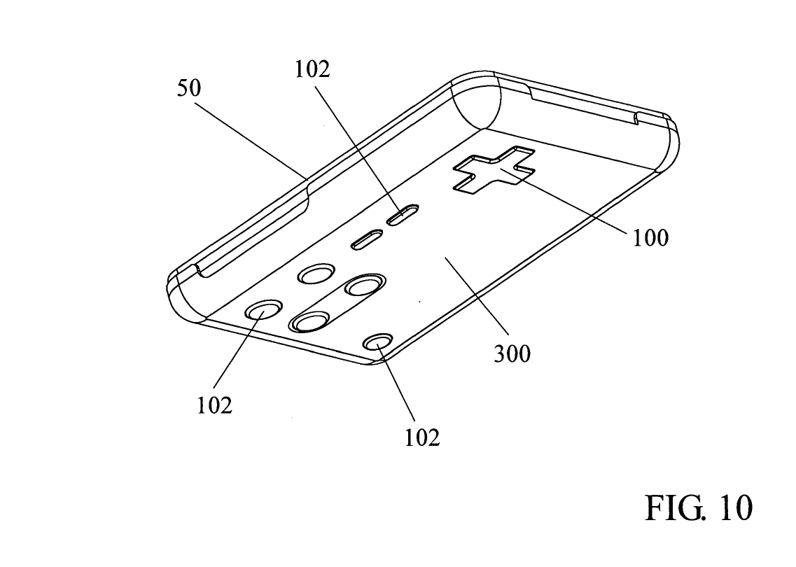

As depicted in FIGS. 7-10, another preferred embodiment of the present invention also discloses a kit for a portable electronic device with a touch screen 51, for example, iPhone® 50 and iPod touch®, wherein the kit comprises: removable pads, comprising seven button pads 102 and one D-pad (4-direction pad) 100, wherein the button pads 102 and the D-pad 100 are able to be pressed to input instruction into the touch screen 51 of iPhone® 50; and a carrying case 300, carrying the removable pads (e.g. 100 and 102) and fitting the portable electronic device 50 to protect therefrom. When it comes to playing mobile games on iPhone® 50, iPod touch®, or any other portable electronic devices with a touchscreen or a touch panel, users may take out the removable pads (e.g. 100 and 102) from the carrying case 300, then putting the removable pads (e.g. 100 and 102) onto the touch screen 51 facilely, and enjoy playing games like using a real, game controller for fun. The removable pads (for instance, 100 and 102) enable the users in contact with iPhone® 50 to feel like interacting with a handheld game console.

Moreover, the texture of the removable pads, including the button pads 102 and the D-pad 100, may simulate game controllers, handheld game consoles, or the like. The material of the removable pads can exert substantial friction against the touch screen 51 to be less slippery. In other words, the material of the removable pads, e.g. 100 and 102, has a coefficient of friction to a considerable extent with respect to the touch screen 51 so as to reduce relative movement between the removable pads (e.g. 100 and 102) and the touch screen 51. The material of the removable pads (e.g. 100 and 102) may include, but not limited to, rubber, resins, plastic resins, silicone rubber, elastomers, polymers, synthetic rubber, synthetic resins, synthetic materials, or the combination thereof. Furthermore, the material of the removable pads may have the elastic properties, be resilient and/or be flexible to enable perfect contact with the touch screen 51 after pressing button pads 102 or the D-pad 100.

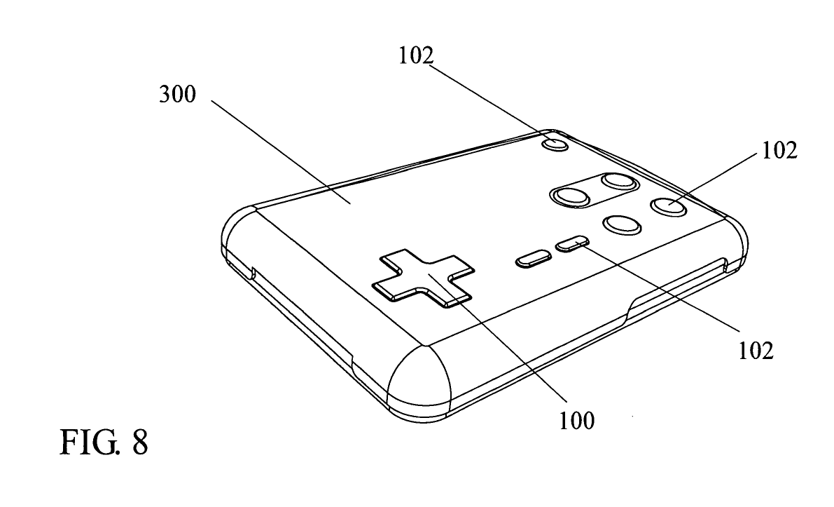

Referring to FIGS. 8-10, the carrying case 300 is able to keep the removable pads (e.g. 100 and 102) between the case 300 and the portable electronic device 50 while the removable pads are not in use. The carrying case 300 may comprise eight holes 304 for aforementioned seven button pads 102 and the D-pad 100 to fit the shape of the removable pads (for example, 100 and 102), and the removable pads (e.g. 100 and 102) are able to be embedded in the holes 304. Additionally, the integral design of iPhone® 50 after “wearing” the carrying case 300 may mimic a game controller, and users or subscribers of mobile games will be fond of this sort of styles.

Besides, the above-mentioned removable pads may further comprise one or more joystick(s) (not shown) which will be able to control the touch screen 51 as well.

In still another preferred embodiment, the present invention provides a kit for a portable electronic device 50 with a touch screen 51, such as iPhone®, iPod touch®, a smartphone, a PDA, and a mobile phone with a touch panel, wherein the kit comprises: removable pad(s), comprising at least one button 102, and/or at least one D-pad 100, wherein the button pad(s) 102 and the D-pad(s) 100 are able to be pressed to input instruction into the touch screen 51 of the portable electronic device 50; and a carrying case 200, carrying the removable pads (e.g. 100 and 102) and fitting the portable electronic device 50 to protect therefrom. The carrying case 200 may further comprise a flat flip-up lid 202 to keep the removable pads (e.g. 100 and 102) between the flip-up lid 202 and the carrying case 200. The flip-up lid 202 may comprise at least one hole 204 for the button pad(s) 102 and/or the D-pad(s) 100 to fit the shape of the removable pads (e.g. 100 and 102), and the removable pads (e.g. 100 and 102) are able to be embedded in the holes 204.

Furthermore, the flat flip-up lid 202 may have one end 206 as a pivot mechanically connected to the carrying case 200 with the other end 208 capable of flipping up from the carrying case 200. Moreover, the flip-up lid 202 may have one end 206 comprising a living hinge or similar mechanism for allowing the other end 208 to be separated into an open position.

Additionally, the material of said carrying cases may include, but not limited to, the plastic, rubber, resins, plastic resins, silicone rubber, elastomers, polymers, synthetic rubber, synthetic resins, synthetic materials, leather, synthetic leather, metals, alloys, or the combination thereof. The material of said flip-up lid may include, but not limited to, the plastic, rubber, resins, plastic resins, silicone rubber, elastomers, polymers, synthetic rubber, synthetic resins, synthetic materials, leather, synthetic leather, metals, alloys, or the combination thereof.

The foregoing description, for purposes of explanation, was set forth in specific details of the preferred embodiments to provide a thorough understanding of the invention. However, it will be apparent to one skilled in the art that specific details are not required in order to practice the invention. Thus, the foregoing descriptions of specific embodiments of the invention are presented for purposes of illustration and description only and should not be construed in any way to limit the scope of the invention. They are not intended to be exhaustive or to limit the invention to the precise forms disclosed; obviously, many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following Claims and their equivalents define the scope of the invention.

What is claimed is:

1. A removable pad for a touch screen of a portable electronic device, which comprises at least one button pad, and/or at least one D-pad, wherein said button pad(s) and said D-pad(s) are able to be pressed to input instruction into said portable electronic device from said touch screen through said at least one button pad, and/or at least one D-pad.

2. The removable pad for a touch screen of a portable electronic device of claim 1, wherein the material of said removable pad exerts substantial friction against said touch screen.

3. The removable pad for a touch screen of a portable electronic device of claim 1, wherein the material of said removable pad includes rubber, resins, plastic resins, silicone rubber, elastomers, polymers, synthetic rubber, synthetic resins, synthetic materials, or the combination thereof.

4. The removable pad for a touch screen of a portable electronic device of claim 1, wherein the material of said removable pad is having the elastic properties, resilient, and/or flexible.

5. The removable pad for a touch screen of a portable electronic device of claim 1, wherein said removable pad further includes a carrying case for said portable electronic device with said touch screen, whereby said carrying case is able to carry said removable pad(s) and fit said portable electronic device to protect therefrom.

6. The removable pad for a touch screen of a portable electronic device of claim 5, wherein said carrying case further comprises a flip-up lid to keep said removable pad(s) between said flip-up lid and said carrying case.

7. The removable pad for a touch screen of a portable electronic device of claim 6, wherein said flip-up lid comprises at least one hole for said button pad(s) and/or said D-pad(s) to fit the shape of said removable pad(s), whereby said removable pad(s) is able to be embedded in said hole(s).

8. The removable pad for a touch screen of a portable electronic device of claim 6, wherein said flip-up lid has one end as a pivot mechanically connected to said carrying case with the other end capable of flipping up from said carrying case.

9. The removable pad for a touch screen of a portable electronic device of claim 6, wherein said flip-up lid has one end comprising a living hinge or similar mechanism for allowing the other end to be separated into an open position.

10. The removable pad for a touch screen of a portable electronic device of claim 1, further comprising one or more joystick(s) able to control said touch screen of said portable electronic device.

11. A kit for a portable electronic device with a touch screen, which comprises:
removable pad(s), comprising at least one button pad, and/or at least one D-pad, wherein said button pad(s) and said D-pad(s) are able to be pressed to input instruction into said portable electronic device from said touch screen through said at least one button pad, and/or at least one D-pad; and
a carrying case, carrying said removable pad(s) and fitting said portable electronic device to protect therefrom.

12. The kit for a portable electronic device with a touch screen of claim 11, wherein the material of said removable pad(s) exerts substantial friction against said touch screen.

13. The kit for a portable electronic device with a touch screen of claim 11, wherein said carrying case further comprises a flip-up lid to keep said removable pad(s) between said flip-up lid and said carrying case.

14. The kit for a portable electronic device with a touch screen of claim 13, wherein said flip-up lid comprises at least one hole for said button pad(s) and/or said D-pad(s) to fit the shape of said removable pad(s), whereby said removable pad(s) is able to be embedded in said hole(s).

15. The kit for a portable electronic device with a touch screen of claim 13, wherein said flip-up lid has one end as a pivot mechanically connected to said carrying case with the other end capable of flipping up from said carrying case.

16. The kit for a portable electronic device with a touch screen of claim 13, wherein said flip-up lid has one end comprising a living hinge or similar mechanism for allowing the other end to be separated into an open position.

17. The kit for a portable electronic device with a touch screen of claim 11, wherein the material of said removable pad(s) is having the elastic properties, resilient, and/or flexible, said material including rubber, resins, plastic resins, silicone rubber, elastomers, polymers, synthetic rubber, synthetic resins, synthetic materials, or the combination thereof.

18. The kit for a portable electronic device with a touch screen of claim 11, wherein said carrying case further comprises at least one hole for said button pad(s) and/or said D-pad(s) to fit the shape of said removable pad(s), whereby said removable pad(s) is able to be embedded in said hole(s).

19. The kit for a portable electronic device with a touch screen of claim 11, wherein said removable pad(s) further comprises one or more joystick(s) able to control said touch screen of said portable electronic device.

20. The kit for a portable electronic device with a touch screen of claim 11, wherein the material of said carrying case and said flip-up lid includes the plastic, rubber, resins, plastic resins, silicone rubber, elastomers, polymers, synthetic rubber, synthetic resins, synthetic materials, leather, synthetic leather, metals, alloys, or the combination thereof.
